(19) United States
(12) Patent Application Publication
(10) Pub. No.: US 2014/0142948 A1
(43) Pub. Date: May 22, 2014

(54) SYSTEMS AND METHODS FOR IN-VEHICLE CONTEXT FORMATION

(71) Applicants: Somya Rathi, Portland, OR (US); Victor B. Lortz, Beaverton, OR (US)

(72) Inventors: Somya Rathi, Portland, OR (US); Victor B. Lortz, Beaverton, OR (US)

(21) Appl. No.: 13/683,243

(22) Filed: Nov. 21, 2012

(51) Int. Cl. G06F 3/16

(52) U.S. Cl. CPC G06F 3/167
USPC 704/270.1

(57) ABSTRACT

Systems, methods, and computer program products directed to in-vehicle context formation are described. Data from one or more sources associated with a vehicle may be received. Context information may be identified, based upon, at least in part, the received data. Audio captured from the vehicle may be received. The context information may be processed based upon, at least in part, at least one of the data from the one or more sources or the received audio.

### TECHNICAL FIELD

Embodiments of this disclosure relate generally to information systems in vehicles, and more particularly, to in-vehicle context formation.

### BACKGROUND

Context-aware systems are aware of the context in which they are run and are able to adapt to changes in the context, such as environment, location, nearby people, and accessible devices. Sensor information available in devices may be obtained to gain access to different types of data to form or augment context information associated with a system or user. For example, location information of a user or device is a type of contextual information that may be used to filter information to identify nearby services or points of interest. Such location information may be obtained through a GPS device of a vehicle or an electronic device.

### BRIEF DESCRIPTION OF THE FIGURES

The detailed description is set forth with reference to the accompanying figures. In the figures, the left-most digit(s) of a reference number identifies the figure in which the reference number first appears. The use of the same reference numbers in different figures indicates similar or identical items.

FIG. 1 is a block diagram of a configuration for in-vehicle context formation, in accordance with an embodiment of the disclosure.

FIG. 2 is a diagram of an in-vehicle context formation system, in accordance with an embodiment of the disclosure.

FIG. 3 is a diagram of an in-vehicle context formation system, in accordance with an embodiment of the disclosure.

FIG. 4 is a diagram of in-vehicle context organization of data, in accordance with an embodiment of the disclosure.

FIG. 5 is a flow diagram of a method for in-vehicle context formation, in accordance with an embodiment of the disclosure.

Certain implementations will now be described more fully below with reference to the accompanying drawings, in which various implementations and/or aspects are shown. However, various aspects may be implemented in many different forms and should not be construed as limited to the implementations set forth herein; rather, these implementations are provided so that this disclosure will be thorough and complete, and will fully convey the scope of the disclosure to those skilled in the art. Like numbers refer to like elements throughout.

### DETAILED DESCRIPTION

Embodiments of the disclosure are described more fully hereinafter with reference to the accompanying drawings in which embodiments of the disclosure are shown. This invention may, however, be embodied in many different forms and should not be construed as limited to the embodiments set forth herein; rather, these embodiments are provided so that this disclosure will be thorough and complete, and will fully convey the scope of the invention to those skilled in the art. Like numbers refer to like elements throughout.

Certain embodiments herein may be directed to in-vehicle context formation. A vehicle may include one or more processors, networking interfaces, and other computing devices that may enable it to receive data and process context information. Using an iterative approach, context information may be regularly processed which may lead to richer context formation. For example, the vehicle may capture audio data of one or more occupants in the vehicle and process the audio data based upon, at least in part, speech recognition and conversation interpretation functionality. The information processed from the audio data may be used to generate or process context information. Additionally, the vehicle may receive data from various sources, including but not limited to, vehicle sensors, navigation system, a calendar, or a contact list. The vehicle may also receive data from an electronic devices associated with the vehicle. The vehicle may process context information, based upon, at least in part, the received data.

Context information may be used to enhance the digital content delivery to the occupants of a vehicle and to enhance the interaction of occupants of the vehicle with the in-vehicle infotainment (IVI) system. Recommendations or related information may be obtained based upon the context information for a trip by the vehicle. Examples of such information may include current traffic conditions en route to a destination, recommendations for hotels, and recommendations for restaurants. Example embodiments of the invention will now be described with reference to the accompanying figures.

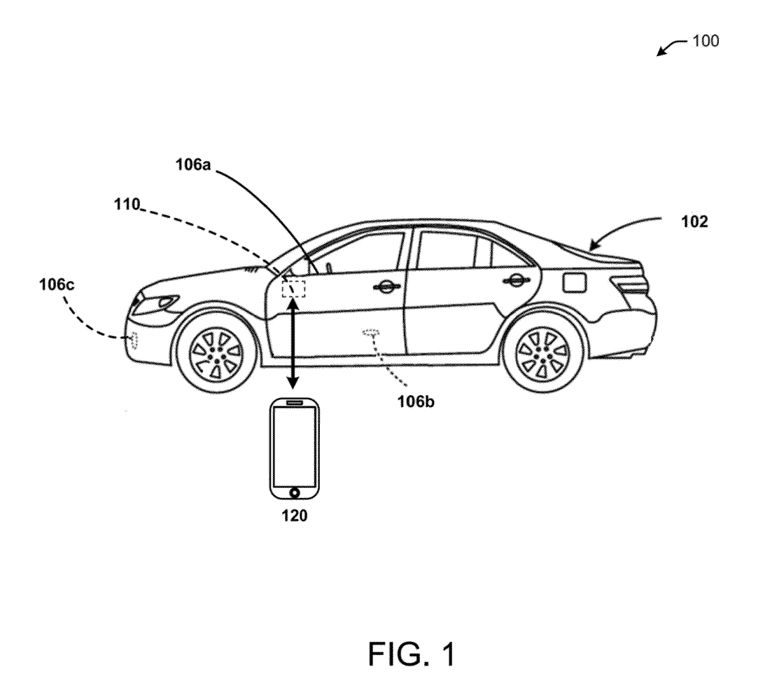

Referring now to FIG. 1, illustrates an example system configuration 100, in accordance with an embodiment of the disclosure, for in-vehicle context formation. The configuration may include, but is not limited to one or more vehicles 102. The vehicle 102 may include one or more systems that include one or more processing devices for implementing functions and features associated with the vehicle 102, as will be discussed in greater detail below. The vehicle 102 may include one or more vehicle sensors 106a-106c (collectively referred to as 106) capable of capturing data associated with the vehicle 102. For example, a microphone 106a may capture audio of one or more occupants of the vehicle. A seat weight sensor 106b may capture the presence of one or more occupants of the vehicle 102 by determining a person is sitting in a particular seat of the vehicle 102. A camera 106c of the vehicle 102 may capture data regarding road conditions as the vehicle 102 progresses on its trip.

The vehicle 102 may include a vehicle on-board platform, such as an in-vehicle infotainment (IVI) system 110. As used herein, an IVI system 110 may refer to a system in a vehicle that provides entertainment and informational features for the vehicle 102. The IVI system 110 may be part of the vehicle's main computer or a stand-alone system. The IVI system 110 may communicate with a system for in-vehicle context formation, as described herein. The IVI system 110 may further include one or more processors communicatively coupled to an electronic memory, described in greater detail below.

The IVI system 110 may also be configured to be coupled to an electronic device 120. The electronic device 120 may include one or more electronic device processors communicatively coupled to an electronic device memory, as well as user interface and an output element, such as a speaker of the vehicle 102. The electronic device 120 may communicate with the vehicle 102 via a communicative link. In certain embodiments herein, devices related to the implementation of in-vehicle context formation may exist onboard an IVI system 110 such that the functionality described herein may be associated with the IVI system 110. In other embodiments, the functionality described herein may reside independently of other systems or may be associated with various other systems.

The IVI system 110 may be in communication with one or more electronic devices 120. In one aspect, an electronic device 120 may serve as an extension of the IVI system 110. For example, if the IVI system 110 does not have Internet capabilities, the IVI system 110 may communicate with an electronic device 120 associated with the vehicle 102 to utilize the communication capabilities of the electronic device 102.

The communicative link may be any suitable electronic communication link including, but not limited to, a hardwired connection, a serial link, a parallel link, a wireless link, a Bluetooth® channel, a ZigBee® connection, a wireless fidelity (Wi-Fi) connection, a Near Field Communication (NFC) protocol, a proprietary protocol connection, or combinations thereof. In one aspect, the communicative link may be secure such that it is relatively difficult to intercept and decipher communications between the electronic device 120 and the IVI system 110. In certain embodiments, the communicative link may be encrypted. Further, in certain embodiments, the communications may be encrypted at more than one open systems interconnections (OSI) model layer. For example, the communications between the electronic device 120 and the vehicle 102 may be encrypted at both the application layer and the transport layer. In some embodiments, the communicative link may be through the communication capabilities of an electronic device 120 associated with the vehicle 102. For example, if the vehicle 102 does not have Internet capabilities, the IVI system 110 may be able to access data through its association with, for example, a smartphone with cellular communication capabilities.

It will be appreciated that the electronic device 120 in communication with the IVI system 110 may provide information or entertainment to occupants within the vehicle 102. Further, the electronic device 120 may be removed from the vehicle 102. As an example, a particular electronic device 120 may be used by a user for her own personal computing or entertainment needs outside of the vehicle 102. The same electronic device 120, when brought into the vehicle 102, may serve the purpose of providing an interface for the IVI system 110 of the vehicle 102, wherein the IVI system 110 and the electronic device 120 have been paired. In such a situation, the electronic device 120 may have all the functions of a similar electronic device 120 that has not been paired to the IVI system. At the same time, the paired electronic device 120 may provide an interface for the IVI system 110 without diminishing the stability of the IVI system 110. In certain aspects, the paired electronic device 120 may have access to more information related to the vehicle 102 than an electronic device 120 that is not paired to the IVI system 110.

In some embodiments, pairing the IVI system 110 and the electronic device 120 may include establishing a connection between the IVI system 110 and the electronic device 120 and authenticating or authorizing the electronic device 120. Authenticating or authorizing the electronic device 120 may include using a security token, a security certificate, a user name and password, an electronic passcode, or other security measure to establish a secure connection between the IVI system 110 and the electronic device 120. Once authenticated, the electronic device 120 may be considered a trusted source of data for the IVI system 110. In some embodiments, the IVI system 110 may be considered a trusted source of data for the electronic device 120.

For the purposes of this discussion, the vehicle 102 may include, but is not limited to, a car, a truck, a light-duty truck, a heavy-duty truck, a pickup truck, a minivan, a crossover vehicle, a van, a commercial vehicle, a private vehicle, a sports utility vehicle, a tractor-trailer, an aircraft, an airplane, a jet, a helicopter, a space vehicle, a watercraft, a motorcycle, or any other suitable vehicle with information and media capability. However, it will be appreciated that embodiments of the disclosure may also be utilized in other transportation or non-transportation related application where electronically securing one device to another device may be implemented.

For the purposes of this discussion, the electronic device 120 may include, but is not limited to, a tablet computer, a notebook computer, a netbook computer, a personal digital assistant (PDA), a cellular telephone, a smart phone, a digital reader, or any other suitable electronic device with communicative, processing, and storage capabilities. In one aspect, the electronic device 120 may be a portable or mobile electronic device.

Vehicle sensors 106 may be any suitable data gathering element associated with the vehicle 102. As a result, vehicle sensors 106 may gather audio, visual, tactile, or environmental information within or associated with the vehicle 102. For example, the seat weight sensors 106b may gather data that may be processed to determine the number of occupants in the vehicle 102. In some embodiments, the vehicle sensors 106 may include one or more cameras 106c within the cabin and/or outside of the vehicle that may capture images of occupants as well as scene information, such as lighting conditions within the vehicle 102 or weather outside of the vehicle 102. As another example, the vehicle sensors 106 may include a GPS device that may indicate a location of the vehicle 102. The vehicle sensors 106, may communicate with the IVI system 110 to capture information associated with the one or more occupants of the vehicle 102. Additionally, the vehicle sensors 106 may transmit signals to the IVI system 110 for providing input from occupants of the vehicle 102.

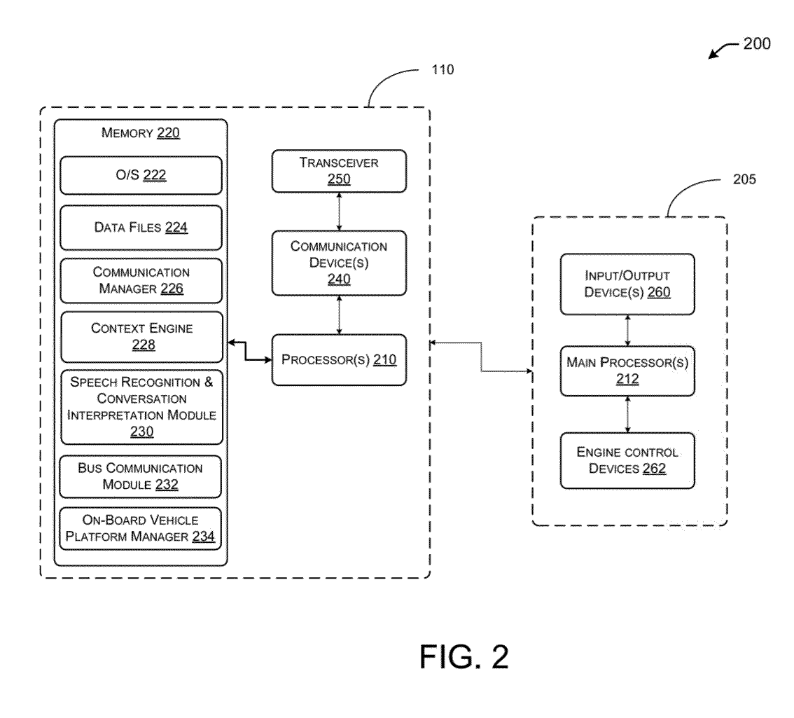

FIG. 2 depicts a block diagram of an example vehicle computing system 200 in a vehicle, e.g., vehicle 102 in FIG. 1, for implementing in-vehicle context formation, among other things. As shown in FIG. 2, multiple vehicle systems may exist. For example, a computing system 205 may exist for controlling a vehicle's standard devices or components, which may include engine devices, braking devices, power steering devices, door control devices, window control devices, etc., in one embodiment. The computing system 205 may also include various input/output (“I/O”) devices 260 that may exist in a vehicle, such as image sensors or collection devices (e.g., a microphone 106a, a seat weight sensor 106b, cameras 106c, both interior-facing cameras for capturing images within a vehicle and exterior-facing cameras for capturing images from a vehicle's surroundings) and display devices, such as light-emitting diode (“LED”) displays and organic light-emitting diode (“OLED”) displays, as non-limiting examples. A main processor 212 may communicate with the standard engine control devices 262 and I/O devices 260 to activate the devices, send information to these devices, or collect information from these devices, as non-limiting examples.

The computing system 205 may be in communication with the IVI system 110. As used herein, an IVI system may refer to a system in a vehicle that provides entertainment and informational features for the vehicle.

The IVI system 110 may include, but is not limited to, a processor 210, a memory 220, one or more communication devices 240, and a transceiver 250. The processor 210 may communicate with the communication devices 240 in the IVI system 110. For example, the processor 210 may communicate with the memory 220 to execute certain computer-executable instructions or modules, such as 226, 228, 230, 232, 234, stored in the memory 220 to facilitate the in-vehicle context formation as described herein. In one embodiment, the processor 210 may also communicate with the one or more communication devices 240 to send and receive messages from various types of networks, such as those listed above. A transceiver 250 may facilitate the sending and receipt of such messages. In some embodiments, a transmitter and a separate receiver may be utilized to send and receive messages, respectively.

According to certain embodiments herein, the processor 210, the memory 220, the communication devices 240, and the transceiver 250 may be onboard a system board (hereinafter “onboard”) in the IVI system 110. In this way, these devices may operate out of band, or with access to only minimal power, such as in association with a vehicle shutdown, hibernation, or standby, as non-limiting examples. In one example, a backup battery may be used to provide sufficient power to enable the devices in the IVI system 110 to operate out of band. Thus, the devices in the IVI system 110 may remain awake (e.g., after a vehicle has been shutdown) and may provide certain functionality, such as communicating with a user device, e.g., electronic device 120, to send and receive messages in association with in-vehicle context formation. Such functionality may be referred to herein as out of band or operating out of band. The devices in the IVI system 110 may also communicate with one another while operating out of band. The processor 210 may, for example, may communicate with the memory 220 to execute computer-executable instructions or modules therein while operating out of band.

The devices and/or program modules in the computing system 205 may shut down when a vehicle is powered down, for example, and therefore may not operate out of band. For example, a main operating system (not shown) that may control standard components in a vehicle, such as an engine, brakes, doors, windows, hard disks, or other devices in communication with the main operating system or one of its program modules, may not be operational when the vehicle 102 is shut down. The O/S 222 in the memory 220, however, may be operational when the vehicle 102 is shut down, or otherwise in a low power state such as hibernation or standby, because it may be located onboard or at the board level in firmware, according to certain embodiments herein. Such a configuration may enable devices in the IVI system 110 to send messages, receive messages, and cause the performance of in-vehicle context formation. As an example, according to certain embodiments, the processor 210 of the IVI system 110 may communicate with the main processor 212 (and/or other devices) of the computing system 205 to wake the main processor 212 so that it may cause performance of the functions requested by a user via an electronic device 120. In one embodiment, such communication may occur via the communicative link.

In certain embodiments, the processor 210 of the IVI system 110 may also communicate with the main processor 212 and/or other devices of the computing system 205 in response to executing computer-executable instructions in the context engine 228 to generate or process context information.

The processors 210 and 212 may include any number of suitable processing devices, such as a central processing unit (“CPU”), a digital signal processor (“DSP”), a reduced instruction set computer (“RISC”), a complex instruction set computer (“CISC”), a microprocessor, a microcontroller, a field programmable gate array (“FPGA”), or any combination thereof. In one embodiment, the system 200 may be based on an Intel® Architecture system, and the processors 210 and chipset may be from a family of Intel® processors and chipsets, such as the Intel® Atom® processor family. The processor 210 may also include one or more processors as part of one or more application-specific integrated circuits (“ASICs”) or application-specific standard products (“ASSPs”) for handling specific data processing functions or tasks. Additionally, any number of suitable I/0 interfaces and/or communications interfaces (e.g., network interfaces, data bus interfaces, etc.) may facilitate communication between the processors 210 and other components of the system 200.

The one or more communication devices 240 may facilitate communications between the system 200 and other devices that may be external to a vehicle 102 containing the system 200. For example, the one or more communications devices 240 may enable the system 200 to receive messages from an electronic device 120 and/or send messages to an electronic device 120 as illustrated in FIG. 1. The communication devices 240 may enable various types of communications over different networks, such as wireless networks including, but not limited to, a wireless fidelity (WiFi) network, a WiFi Direct network, a NFC connection, a radio network, a cellular network, a GPS network, a ZigBee® connection, a Bluetooth® channel, proprietary protocol connections, and other wireless links, as well as hardwired connections, serial link connections, parallel link connections or combinations thereof.

According to various configurations, one or multiple interface cards or circuits may support the multiple networks named above. In one embodiment, such one or more interface cards or circuits may be onboard such that firmware in the memory 220 may access and control communications associated with the customized system 110.

The communication manager module 226 may also send messages using one or more interface cards associated with the various types of networks. As will be described below, the communication manager module 226 may prioritize which channels to use for communicating with an electronic device 120. In addition to onboard interface cards, externally facing devices may also be used to communicate messages over various types of networks.

Turning now to the contents of the memory 220, the memory 220 may include any number of suitable memory devices, such as caches, read-only memory devices, random access memory (“RAM”), dynamic RAM (“DRAM”), static RAM (“SRAM”), synchronous dynamic RAM (“SDRAM”), double data rate (“DDR”) SDRAM (“DDR-SDRAM”), RAM-BUS DRAM (“RDRAM”), flash memory devices, electrically erasable programmable read only memory (“EEPROM”), non-volatile RAM (“NVRAM”), universal serial bus (“USB”) removable memory, magnetic storage devices, removable storage devices (e.g., memory cards, etc.), and/or non-removable storage devices. As desired, the memory 220 may include internal memory devices and/or external memory devices in communication with the system 200.

The memory 220 may store data, executable instructions, and/or various program modules utilized by the processor 210. Examples of data that may be stored by the memory 220 include data files 224 and any number of suitable program modules and/or applications that may be executed by the processor 210, such as, but not limited to, an operating system (“OS”) 222, an a communication manager module 226, a context engine module 228, a speech recognition and conversation interpretation module 230, a bus communication module 232, and an on-board vehicle platform manager module 234. Each of these modules may be implemented as individual modules or, alternatively, one or more of the modules may perform all or at least some of the functionality associated with the other modules. In certain embodiments, these modules may be stored as firmware in a read-only memory 220, thereby making it more difficult for the functions described herein to be tampered with or disabled.

The data files 224 may include any suitable information that may facilitate the in-vehicle context formation. Example information may include, but is not limited to, information that may be used to associate an electronic device 120 with the IVI system 110, tracking information associated with requests from user devices 120 and responses to such requests, as well as other information that may facilitate the processes described herein.

The operating system 222 may include a suitable module or application that facilitates general operation of the system 200, as well as the execution of other program modules illustrated in the memory 220 in FIG. 2.

The communication manager module 226 may perform a number of functions to facilitate communications between the system 200 and various other devices, such as a user device 120 in FIG. 1. As described above, the communication manager module 226 may communicate with one or more communication devices 240, such as network interface cards, to receive and send messages to user devices 120 using multiple types of networks. In association with such communication, the communication manager module 226 may determine a network among multiple available networks for communicating with a device 120, may prioritize the networks according to various criteria, and may send messages over a selected network to a vehicle 102, for example.

The context engine 228 may perform a number of functions to facilitate formation and processing of context information. For example, context engine 228 may identify existing context information based upon received data, generate context information based upon received data, or process (e.g., augment or update) context information based upon received data. The context engine 228 may obtain related information using the context information, such as recommendations or other information that may be used to assist the driver or occupant of the vehicle 102. Context engine 228 may transmit the related information to an output device 260 associated with the vehicle to be displayed to the driver or occupant of the vehicle 102.

The speech recognition and conversation interpretation (SRCI) module 230 may perform a number of functions to facilitate processing audio data. SRCI module 230 may receive captured audio data from context engine 228 or from an I/O device 260 of the vehicle, such as a microphone 106a. SRCI module 230 may process the audio data to obtain or extract information. The information from the audio data may be used by SRCI module 230 or context engine 228 to further process context information. For example, data extracted by SRCI module 230 from audio data may be used by SRCI module 230 to update existing context information. SRCI module 230 may receive context information from context engine 228 to enhance data extraction from audio data. For example, SRCI module 230 may use context information to identify words or phrases prioritized by context engine module 228 to extract or obtain particular information from the audio data.

One or more bus communication modules 232 may include various protocols that may be used by devices in the system 200 to communicate with one another. An example protocol may be the CAN (controller area network) BUS protocol, in which communication occurs between devices over a controller area network without a host computer device. For example, the processor 210 may use the CAN BUS protocol to communicate with a main processor 212 to wake the main processor 212 and instruct it to activate an I/O device 260, in one example. Protocols in addition to the CAN BUS protocol, such as other message-based protocols, may be used in other embodiments. In other examples, a chipset (not shown) may be provided to control communications between the devices in the vehicle computing system 200.

An on-board vehicle platform manager module 234 may perform a number of functions to facilitate transfer of data between the context engine module 228 and other components of the system. For example, on-board vehicle platform manager module 234 may receive manually entered information from an occupant of the vehicle 102 through a user interface of the IVI system 110. The on-board vehicle platform manager module 234 may transmit the information to context engine 228. On-board vehicle platform manager 234 may obtain stored context information from a specified location, such as on a server or a cloud service, and transmit the information to the context engine 228. Further, on-board vehicle platform manager module 234 may receive processed context information 310 from context engine 228 and information related to the context information 310 and transmit the data to an I/O device for display to the driver of the vehicle 102.

In addition to or alternative to the memory 220, other embodiments may include one or more suitable computer-readable media that may be provided for storing computer-executable instructions such as those stored in the memory 220. One or more processing devices, such as the processor 210, may execute such computer-executable instructions to facilitate the remote management of a vehicle, as described above in association with the modules 226, 228, 230, 232 in the memory 220. As used herein, the term “computer-readable medium” may describe any form of suitable memory or memory device for retaining information in any form, including various kinds of storage devices (e.g., magnetic, optical, static, etc.) that is non-transitory. Indeed, various embodiments of the disclosure may be implemented in a wide variety of suitable forms.

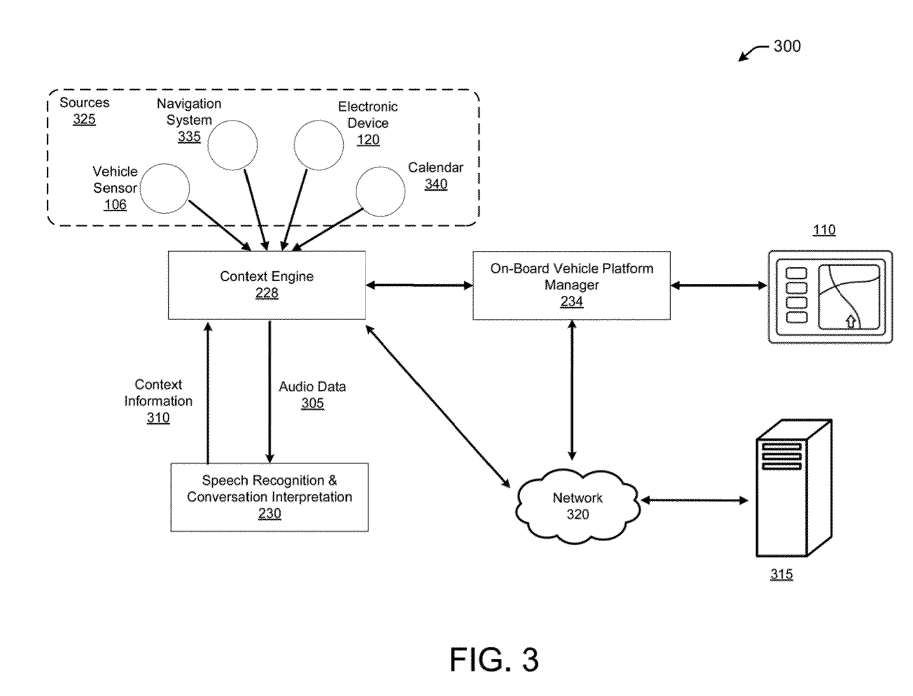

FIG. 3 depicts a diagram of an in-vehicle context formation system, in accordance with one embodiment of the disclosure. In brief overview, system 300 may include one or more sources 325 associated with a vehicle 102. Sources 325 may include, but are not limited to, vehicle sensors 106, a navigation system 335, an electronic device 120, and a calendar 340. A context engine 228 may receive data from one or more data sources 325. Context information 310 may be transmitted to SRCI module 230. The SRCI module 230 may receive audio data 305 of one or more occupants of the vehicle 102 from one or more microphones 106a. The SRCI module 230 may receive audio 305, process the audio data 305, and process context information 310 based upon, at least in part, the data from the processed audio. The processed context information 310 may be transmitted from the SRCI module 230 back to the context engine 228. The context engine 228 and/or SRCI module 230 may communicate with the on-board vehicle platform manager module 234. Data may be obtained from one or more occupants of the vehicle 102 through a user interface of the IVI system 110 and transmitted to the context engine 228 by on-board vehicle platform manager module 234. Likewise, the context engine 228 may transmit context information and/or information related to the context information to the IVI 110 system through the on-board vehicle platform manager module 234.

System 300 may include one or more sources 325 associated with a vehicle 102. Sources 325 may include, but are not limited to, vehicle sensors 106, a navigation system 335, an electronic device 120 associated with the vehicle 102, and a calendar 340. A vehicle sensor 106 may be a hardware sensor in the vehicle 102 that is capable of collecting information related to the vehicle 102, the environment, and/or occupants of a vehicle 102. Examples of a vehicle sensor 106 that may be a hardware sensor may include a seat weight sensor 106b, a camera 106c (e.g., dashboard camera and/or an exterior camera), a thermometer, GPS device, a microphone 106a, engine sensors, a navigation system 335, or other types of sensors capable of collecting data. A vehicle sensor 106 may be a soft sensor, such as a calendar 340 associated with the vehicle 102, a calendar 340 associated with an occupant of the vehicle 102, an address book or contact list associated with the vehicle 102, or an address book or contact list associated with an occupant of the vehicle 102.

In some embodiments, a source 325 may include data received through a communicative link, such as a Bluetooth® connection, a WiFi connection, a cellular connection over a network 320, or other communication link as described herein. Data may be received from one or more servers 315 hosted outside of the vehicle 102 or data repositories, such as databases. A server 315 may be a computing device outside of the vehicle 102 in communication with the vehicle 102 through the network 320.

A context engine 228 may receive data from one or more data sources 325. In some embodiments, context engine 228 may reside within the IVI 110, as a part of the vehicle's main computer, or as stand-alone system. In some embodiments, the context engine 228 may reside on an electronic device 120 associated with the vehicle 102. The context engine 228 may reside on one or more servers 315 outside of the vehicle 102 and connected through a communicative link or Internet connection. The context engine 228 may perform various functions, which may include, but are not limited to, receiving and/or obtaining data from sources 325, processing context information 310, retrieving and/or identifying existing context information 310, updating, augmenting, modifying or otherwise processing existing context information 310, storing context information 310, receiving data from one or more occupants of a vehicle 102, communicating with one or more subsystems (e.g., 205, 234) of the vehicle 102, and processing received data and/or context information 310.

Context information 310 may be transmitted to SRCI module 230. The SRCI module 230 may receive the context information 310 to enhance processing of audio data 305. For example, if the SRCI module 230 receives context information 310 indicating that the passengers of the vehicle 102 are on their way to the airport, the SRCI module 230 may prioritize identification of words associated with airports, such as flight delays, destination identification, or identification of airlines.

The SRCI module 230 may receive audio data 305 of one or more occupants of the vehicle 102 from one or more microphones 106a. In some embodiments, the microphone 106a may be a vehicle sensors on-board the vehicle 102. In some embodiments, the microphone 106a may reside on an electronic device 120 associated with the vehicle 102. The SRCI module 230 may receive audio data 305 captured by another subsystem of the vehicle 102. For example, the audio may be captured by the IVI system 110.

The SRCI module 230 may receive captured audio 305, process the audio, and process context information 310 based upon, at least in part, the data from the processed audio. The SRCI module 230 may extract information related to the identified context information 310. The SRCI module 230 may process the context information 310 using data extracted from the audio. The SRCI module 230 may transmit the processed context information 310 back to the context engine 228.

The context engine 228 and/or SRCI module 230 may communicate with the on-board vehicle platform manager module 234, which may communicate with the IVI system 110 of a vehicle 102. In some embodiments, context information 310 may be displayed on an I/O device of the IVI system 110 or on the electronic device 120. In some embodiments, the context engine 228 may obtain information based upon, at least in part, the processed context information 310. In some embodiments, the information may be obtained over a communicative link or from local storage on the vehicle 102. For example, the processed context information 310 may indicate that the flight for a passenger has been cancelled. The context engine 228 may obtain information for possible hotel reservations or information for re-booking the flight for the passenger from the Internet over the network 320.

Additionally, data may be obtained from one or more occupants of the vehicle 102 through the IVI system 110 and transmitted to the context engine 228 by the on-board vehicle platform manager module 234. Likewise, the context engine 228 may transmit context information 310 and/or information related to the on-board vehicle platform manager 234 that then may transmit the context information 310 to the IVI 110 system.

The on-board vehicle platform manager module 234 may receive context information 310, audio data 305, information associated with the context information 310, and/or any additional data from the context engine 228, SRCI module 230, or the IVI system 110. The on-board vehicle platform manager module 234 may transmit the received information over the network 320 to a server 315, a cloud service, or other remote storage location outside of the vehicle. The information may be accessed by the driver or occupant of the vehicle 102 through the IVI system 110 or outside of the vehicle 102, by a computing device and/or electronic device 120.

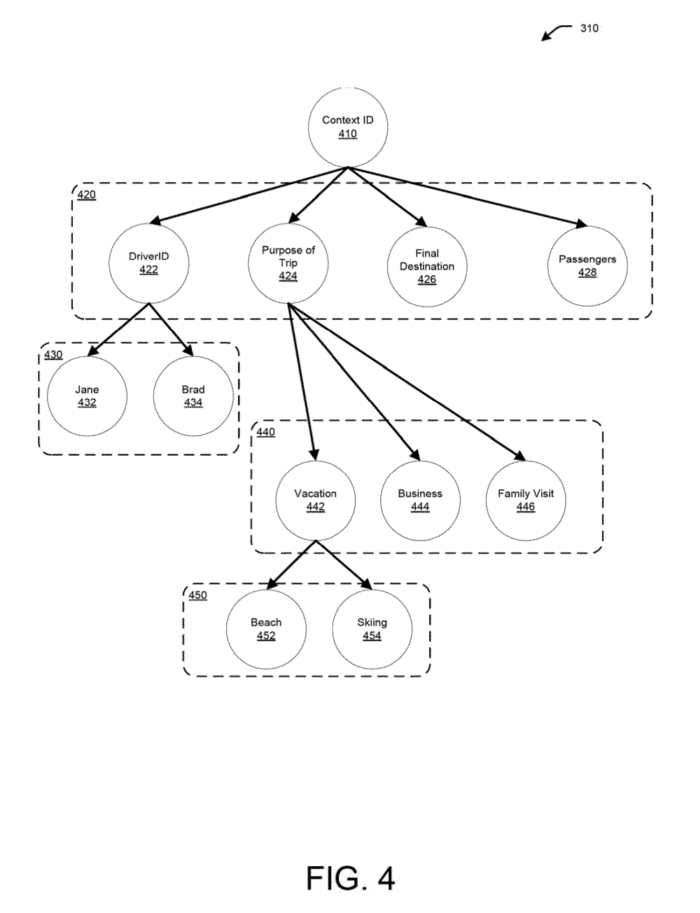

Now referring to FIG. 4, a diagram of an example embodiment of in-vehicle context organization of data is depicted. Context information 310 may be generated or determined using data received from one or more data sources 325 and/or audio data 305 captured from one or more occupants of a vehicle 102. In some embodiments, context information 310 may be organized in a manner which provides a certain bias in the system 200 that makes certain rules or a certain set of actions more likely.

Still referring to FIG. 4, and in more detail, is an example context 310 that may be generated or processed by a context engine 228 or generated or processed based upon a predefined context template, as described herein. A basic context 310 may be identified by a context ID 410. For example, a context 310 may be associated with an identifier, such as a number, or a descriptive name, such as “Trip to Airport”. A context may include one or more fields 420. For example, in the diagram, the displayed context 310 includes the fields DriverID 422, Purpose of Trip 424, Final Destination 426 and Passengers 428.

Information to populate these fields may be received from data sources 325 associated with the vehicle 102, manual input from an occupant of the vehicle 102 (through the IVI system 110 or electronic device 120 associated with the vehicle 102) and/or audio 305 captured from the vehicle 102. For example, DriverID 422 for the displayed context may have information or profiles 430 stored for one or more possible drivers, such as Jane 432 or Brad 434. This information may have been manually entered by a person associated with the vehicle 102, derived from a user profile stored on the vehicle 102 or received from an electronic device 120, may have been obtained through facial recognition based upon images captured by a camera 106c in the vehicle 102, may have been obtained from data from captured audio 305 or any combination thereof. For example, system 300, based upon the voice of the driver of the vehicle 102, may determine that the driver of the vehicle is Brad 434.

Furthering this example, system 300 may determine from data received from the occupant of the vehicle 102 through the IVI system 110 that the Purpose of Trip 424 field, which may include subcategories 440, such as Vacation 442, Business 444, or Family Visit 446, should be Vacation 442. System 300 may process audio 305 captured and processed by system 300 and data received from a calendar 340, may select from one or more possible types of vacations 450, the vacation is likely a beach vacation 452 rather than a skiing vacation 454. The system 300 may prioritize certain words associated with a beach vacation 452 when processing captured audio 305 to obtain more relevant information for the context 310. In one embodiment, system 300 may receive GPS coordinates of the vehicle 102 and determine a final destination 426 based upon the data received. In another embodiment, Passengers 428 may be determined using data received from seat weight sensors 106b, facial recognition data processed from images received from cameras 106c associated with the vehicle 102, and/or audio 305 received from the cabin and/or outside of the vehicle 102.

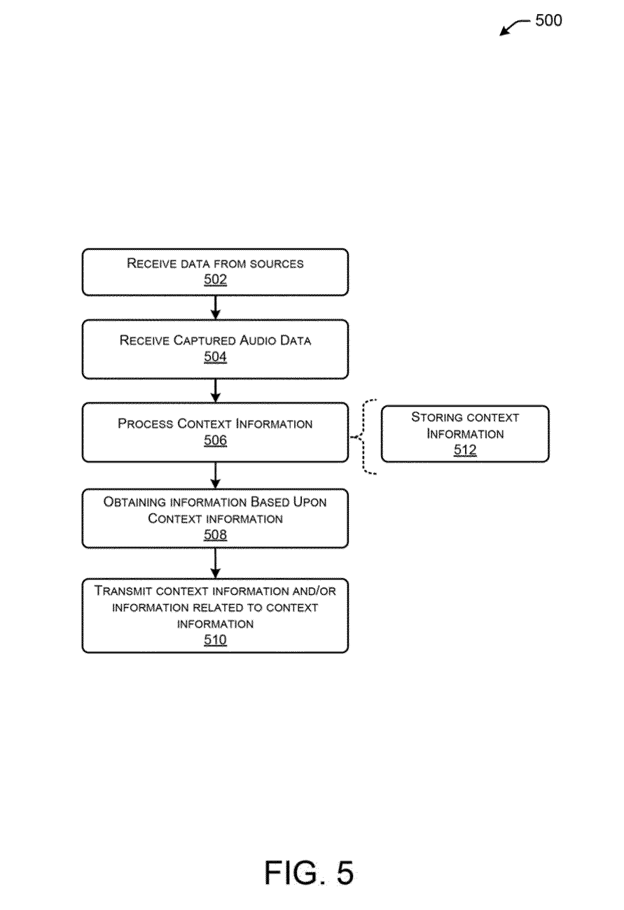

FIG. 5 depicts a method for in-vehicle context formation in accordance with an embodiment of the disclosure. In brief overview, a context engine 228 may receive 502 data from sources 325. The context engine 228 may receive audio data 305. Context engine 228 may process 506 context information, based upon, at least in part, data from the sources 325 and/or the audio data 305. Information based upon context information 310 may be obtained 508 by the context engine 228 or the IVI system 110. Context engine 228 may transmit 510 context information and/or information related to the context information 310 to an I/O device 260 of the vehicle 102. Context information 228 may store 512 context information.

Context engine 228 may receive data. In some embodiments, when a person enters a vehicle 102, they may manually input data into the system 300. The person may manually input information through a user interface of the IVI 110. The person may input information verbally, where a microphone 106a of the system 300 may capture and process the audio data 305. In some embodiments, IVI 110 may automatically recognize an electronic device 120 previously associated with the vehicle 102. System 300 may receive a user profile from the electronic device 120. System 300 may receive an indication from a person identifying one or more occupants of the vehicle 102 or identifying a particular context 310. System 300 may further retrieve one or more profiles corresponding to the identified occupants of the vehicle 102.

System 300 may identify, retrieve, or otherwise obtain context information 310 based upon, at least in part, data received from an occupant of the vehicle 102. In some embodiments, system 300 may determine context information 310 associated with particular occupants of the vehicle 102 does not exist. In some embodiments, context information 310 may be identified or retrieved from profiles that may have been previously created for the occupants of the vehicle 102. If context information 310 does not exist for a particular trip, vehicle 102, or occupant, system 300 may identify or retrieve predefined context templates.

The context engine 228 may have predefined context templates for particular purposes. Predefined contexts may be for specific purposes, such as a trip. A trip may be defined as a commute from point A to point B with one or more people in a vehicle. An example predefined context may be as follows:

{Purpose of Trip} to {Destination} with {Passengers in Vehicle} on {Date} at {Time} for {Duration of Trip}.

Example options for the designated fields in the predefined context may include, but are not restricted to, the following:

{Purpose of Trip} may be a brief description or categorization of the nature of the trip, such as for business, vacation, office commute, or shopping.

{Destination} may be an address, name of destination, or other indicator of the final destination of a trip. Example data may include “Airport”, “Grandma's House”, “XYZ Restaurant”

{Passengers in Vehicle} may indicate the number of people in the vehicle, demographic information, such as gender or age, and/or identities of specific people. The identities of specific people may be useful if the passenger has an existing profile in the IVI system. Example data may include names of pre-defined groups, such as “family”, “kids”, “friends”, “business associates”, and “carpool.” The person may also specifically identify passengers by name or other identifier.

{Date} may indicate the current date of the trip or a particular date as identified by a calendar or entered by the person. Example data may include “weekday”, “birthday of X person” or similar.

{Time} may indicate the current time of the trip.

{Duration of Trip} may be an estimated duration of the trip as entered by the occupant of the vehicle.

The fields may be entered manually by a person, populated automatically from one or more sources 325 of the vehicle 102, received from one or more electronic devices 120 in communication with the vehicle 102, or derived from previously entered information. In some embodiments, only one context 310 may be active for a trip. In some embodiments, multiple contexts 310 may be active for a trip.

The context engine 228 may receive 502 data from sources 325. In some embodiments, data may be received from one or more sources 325 associated with the vehicle 102. A source 325 may be vehicle sensors 106, calendars 340 associated with the vehicle 102 or occupants of the vehicle 102, a navigation system 335 of the vehicle 102, a contact list or address book associated with the vehicle 102 or with an occupant of the vehicle 102, an Internet connection, an electronic device 120 in communication with the vehicle 102 through a communicative link, databases, or other available supply of data. In some embodiments, the context engine 228 may register for updates from one or more sources 325 indicating any updates or modifications of data.

A vehicle sensor 106 may include seat weight sensors, which may capture data used to determine the number of people in the vehicle 102. A camera 106c inside the vehicle 102 may also be a type of vehicle sensor 106. The camera 106c may capture images that may permit the system 300 to determine the number of people in the vehicle 102, characteristics of the people, and identities of the people. Another type of vehicle sensor 106 may be a GPS device, which may provide geographic coordinates or location of the vehicle 102. The GPS device may also provide data other subsystems of the vehicle 102 such as the navigation system 335.

Sources 325 associated with a vehicle 102 may provide many different types of data. For example, a calendar 340 may provide information related to or indicating a purpose of the trip. For example, the calendar 340 may indicate that on a particular day, a person may have a hair appointment. This may provide a possible purpose of a trip for that day. The calendar entry may also provide information as to possible passengers in the vehicle 102, whether the trip is for business or leisure, and possible destination of the appointment.

An electronic device 120 associated with the vehicle 102 may communicate with the vehicle 102 over a communicative link, such as Bluetooth, WiFi, or NFC, and may provide data associated with occupants of the vehicle 102. For example, if an electronic device 120 has a profile stored on it, system 300 may obtain the profile from the electronic device 120, which may include identifying information, preferences of the user, previous context history of the user, or other information. A navigation system 335 and history may provide system 300 with destination information, tentative schedule information based upon previous routines of the user such as weekend grocery shopping routes recorded over a period. A contact list or address book may provide system 300 with information for possible destinations or purposes of trip. For example, if a contact list stores an entry entitled for “Grandma”, if the user indicates the trip destination is “Grandma's House”, system 300 may retrieve an address stored for “Grandma” in the contact list.

System 300 may receive 504 captured audio data 305. Audio data 305 may be captured by one or more microphones 106a. The microphone 106a may be located inside and/or outside the vehicle 102. In some embodiments, audio data 305 may be captured by a microphone 106a of an electronic device 120 associated with the vehicle 102. Audio data 305 may be captured by a combination of one or more microphones 106a. Audio data 305 may be captured by one or more I/O devices 260 of the vehicle 102.

The captured audio 305 may be processed by SRCI module 230. SRCI module 230 may process the captured audio 305 in near real time as conversation is occurring within the vehicle 102. SRCI module 230 may store the captured audio 305 and process the captured audio 305 a later time. SRCI module 230 may receive context information 310 from context engine 228. Based upon, at least in part, the context information 310, SRCI module 230 may prioritize words associated with context information 310 while processing the captured audio data 305. In some embodiments, the audio data 305 may be received by context engine 228 and transmitted to SRCI module 230. In some embodiments, the audio data 305 may be received by SRCI module 230. Audio data 305 may be received from another module of the IVI system 110 or another subsystem of the vehicle 102.

Context information 310 may be processed 506 based upon, at least in part, data received from sources 325 associated with the vehicle 102, audio data 305 processed by SRCI module 230, and/or information manually or verbally entered by one or more occupants of the vehicle 102. In some embodiments, system 300 may determine context information 310 does not exist prior to processing audio data 305. SRCI module 230 may build or generate a basic context 310 or retrieve predefined context information 310 prior to processing the audio data 305. SRCI module 320 may process 506 context information 310 based upon, at least in part, the processed audio data 305. Context engine 228 may receive the processed context information 310 and further process 506 the context information 310 using new, modified, or updated data received from one or more data sources 325 associated with the vehicle 102. For example, GPS device may provide updated location data as the trip progresses. Vehicle sensors 106, such as seat weight sensors, may indicate arrival or departure of occupants during the trip. Such updated data may be received by context engine 228. Context engine 228 may process context information 310 and transmit the context information 310 to SRCI module 230 until the termination of the trip. Such an iterative process may provide more thorough and rich context information 310, as data is continuously received and information is likewise continuously refined and updated to provide relevant information throughout the trip.

Context engine 228 may obtain 508 information based upon, at least in part, context information 310. In some embodiments, the IVI system 110 may obtain 508 information based upon, at least in part, the context information 310. For example, using context information 310, context engine 228 may generate recommendations for the driver. Recommendations may include recommendations and directions for retail stores, hotels, and restaurants. Information based upon the context information 310 may include recommended actions, such as creating a calendar 340 event, retrieving historic information, displaying re-routed directions that may be based upon current traffic or weather conditions, making reservations for different types of events, adding contact information into an address book, or other types of actions.

In some embodiments, the processed context information may be stored 512. The context information 310 may be stored on the vehicle 102, on one or more electronic devices 120 associated with the vehicle 102, on a remote server 315, or in a cloud service. The context information 310 may be stored in a database or in a profile associated with a person, vehicle 102, and/or electronic device 120. In some embodiments, audio data 305, trip history, user requests, and information related to the context information 310, such as recommendations, may also be stored in manner as described herein.

In some embodiments, context engine 228 may transmit 512 information related to the context information 310. For example, context engine 228 may transmit the context information 310 to the on-board vehicle platform manager 234 that may then transmit the data to a user interface of the IVI system 110. Displaying the context information 310 and information related to the context information may enable context engine 228 and/or IVI 110 to provide services that are more relevant for the trip. For example, context engine 228 and/or IVI 110 may proactively fetch relevant information based upon, at least in part, the processed context information 310 to assist the driver or occupants of the vehicle during a trip. The system 300 may perform actions based on data provided by the occupants of the vehicle 102 and/or the context information 310, such as searching for hotel rooms, making reservations at a particular restaurant, re-routing the path to the identified destination of the trip, or buying tickets for events, such as concerts, movies, theater, or sporting events. Information obtained by the system 300 or the context information 310 may be displayed by the IVI 110 of the vehicle and/or by one or more electronic devices 120 associated with the vehicle 102.

In some embodiments, system 300 may receive information from the user configuring one or more policies managing the actions of the system 300. Policies may be configured manually in the vehicle 102, either through speech or through a user interface of the IVI 110. Policies may be configured on an electronic device 120 associated with the vehicle 102 and then transmitted to the vehicle 102. Policies may be configured on a computing device and then transmitted to the vehicle 102 over the network 320.

In some embodiments, a person may configure a policy directing system 300 to interact with the one or more occupants of a vehicle 102 as soon as they enter the vehicle 102. In some embodiments, a person may configure a policy that directs the system 300 to only execute passively in the background, where system 300 is collecting data (e.g., audio data 305) and processing context information 310, but not displaying any information to the occupants or interacting with the occupants of the vehicle 102. Further, policies may be configured to allow system 300 to interact with one or more occupants of a vehicle 102 if a pre-designated keyword or phrase is used during a trip. The identification of the pre-designated keyword or phrase by the system 300 may be a request by the driver or occupant for assistance from system 300. A keyword or phrase may be designated at time of manufacture of the system 300 and modified by a person at a later time. The keyword or phrase may be changed or updated by the driver or occupant of the vehicle 102. The system 300 may request one or more occupants of the vehicle 102 to specify a keyword or phrase if one does not already exist. The keyword or phrase may be designated in the vehicle 102 verbally by the user in the vehicle 102 or through a user interface of the IVI system 110. In some embodiments, the keyword or phrase may be designated on an electronic device 120 associated with vehicle 102 or a computing device and transmitted to the vehicle 102 through over the network 320. During a trip, the captured audio 305 may be processed and the keyword or phrase may be identified. Responsive to the identification of the keyword or phrase, system 300 may interact with the occupants of the vehicle 102. For example, the person may say the pre-designated keyword or phrase and system 300 may begin engaging more interactively with the occupants of the vehicle 102.

A user may also configure policies related to data collection, data storage, data presentation, and other actions. For example, policies may be configured to direct system 300 to display or present information to the occupants, how to display information, and what kind of information to display. A user may configure policies to erase all context information 310 at the conclusion of a trip or responsive to a triggering event, such as on a pre-determined day of the week or time of day. Policies may be directed to storing histories of trips or any data collected from sources 325 of the vehicle 102.

As will be appreciated by one skilled in the art, the present disclosure may be embodied as a method, system, or computer program product. Accordingly, the present disclosure may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, the present disclosure may take the form of a computer program product on a computer-usable storage medium having computer-usable program code embodied in the medium.

Any suitable computer usable or computer readable medium may be utilized. The computer-usable or computer-readable medium may be, for example but not limited to, an electronic, magnetic, optical, electromagnetic, infrared, or semiconductor system, apparatus, device, or propagation medium. More specific examples (a non-exhaustive list) of the computer-readable medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a transmission media such as those supporting the Internet or an intranet, or a magnetic storage device. Note that the computer-usable or computer-readable medium could even be paper or another suitable medium upon which the program is printed, as the program can be electronically captured, via, for instance, optical scanning of the paper or other medium, then compiled, interpreted, or otherwise processed in a suitable manner, if necessary, and then stored in a computer memory. In the context of this document, a computer-usable or computer-readable medium may be any medium that can contain, store, communicate, propagate, or transport the program for use by or in connection with the instruction execution system, apparatus, or device. The computer-usable medium may include a propagated data signal with the computer-usable program code embodied therewith, either in baseband or as part of a carrier wave. The computer usable program code may be transmitted using any appropriate medium, including but not limited to the Internet, wireline, optical fiber cable, RF, etc.

Computer program code for carrying out operations of the present disclosure may be written in an object oriented programming language such as Java, Smalltalk, C++ or the like. However, the computer program code for carrying out operations of the present disclosure may also be written in conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through a local area network (LAN) or a wide area network (WAN), or the connection may be made to an external computer (for example, through the Internet using an Internet Service Provider).

These computer program instructions may also be stored in a computer-readable memory that can direct a computer or other programmable data processing apparatus to function in a particular manner, such that the instructions stored in the computer-readable memory produce an article of manufacture including instruction means which implement the function/act specified in the flowchart and/or block diagram block or blocks.

The computer program instructions may also be loaded onto a computer or other programmable data processing apparatus to cause a series of operational steps to be performed on the computer or other programmable apparatus to produce a computer implemented process such that the instructions which execute on the computer or other programmable apparatus provide steps for implementing the functions/acts specified in the flowchart and/or block diagram block or blocks.

Certain aspects of the disclosure are described above with reference to block and flow diagrams of systems, methods, apparatus, and/or computer program products according to example embodiments. It will be understood that one or more blocks of the block diagrams and flow diagrams, and combinations of blocks in the block diagrams and the flow diagrams, respectively, can be implemented by computer-executable program instructions. Likewise, some blocks of the block diagrams and flow diagrams may not necessarily need to be performed in the order presented, or may not necessarily need to be performed at all, according to some embodiments.

These computer-executable program instructions may be loaded onto a special-purpose computer or other particular machine, a processor, or other programmable data processing apparatus to produce a particular machine, such that the instructions that execute on the computer, processor, or other programmable data processing apparatus create means for implementing one or more functions specified in the flow diagram block or blocks. These computer program instructions may also be stored in a computer-readable memory that can direct a computer or other programmable data processing apparatus to function in a particular manner, such that the instructions stored in the computer-readable memory produce an article of manufacture including instruction means that implement one or more functions specified in the flow diagram block or blocks. As an example, certain embodiments may provide for a computer program product, comprising a computer-usable medium having a computer-readable program code or program instructions embodied therein, said computer-readable program code adapted to be executed to implement one or more functions specified in the flow diagram block or blocks. The computer program instructions may also be loaded onto a computer or other programmable data processing apparatus to cause a series of operational elements or steps to be performed on the computer or other programmable apparatus to produce a computer-implemented process such that the instructions that execute on the computer or other programmable apparatus provide elements or steps for implementing the functions specified in the flow diagram block or blocks.

Accordingly, blocks of the block diagrams and flow diagrams support combinations of means for performing the specified functions, combinations of elements or steps for performing the specified functions and program instruction means for performing the specified functions. It will also be understood that each block of the block diagrams and flow diagrams, and combinations of blocks in the block diagrams and flow diagrams, can be implemented by special-purpose, hardware-based computer systems that perform the specified functions, elements or steps, or combinations of special-purpose hardware and computer instructions.

Conditional language, such as, among others, “can,” “could,” “might,” or “may,” unless specifically stated otherwise, or otherwise understood within the context as used, is generally intended to convey that certain embodiments could include, while other embodiments do not include, certain features, elements, and/or operations. Thus, such conditional language is not generally intended to imply that features, elements, and/or operations are in any way required for one or more embodiments or that one or more embodiments necessarily include logic for deciding, with or without user input or prompting, whether these features, elements, and/or operations are included or are to be performed in any particular embodiment.

The terminology used herein is for the purpose of describing particular embodiments only and is not intended to be limiting of the disclosure. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the present disclosure has been presented for purposes of illustration and description, but is not intended to be exhaustive or limited to the disclosure in the form disclosed. Many modifications and variations will be apparent to those of ordinary skill in the art without departing from the scope and spirit of the disclosure. The embodiment was chosen and described in order to best explain the principles of the disclosure and the practical application, and to enable others of ordinary skill in the art to understand the disclosure for various embodiments with various modifications as are suited to the particular use contemplated.

Many modifications and other embodiments of the disclosure set forth herein will be apparent having the benefit of the teachings presented in the foregoing descriptions and the associated drawings. Therefore, it is to be understood that the disclosure is not to be limited to the specific embodiments disclosed and that modifications and other embodiments are intended to be included within the scope of the appended claims. Although specific terms are employed herein, they are used in a generic and descriptive sense only and not for purposes of limitation.

What is claimed is:

1. A computer-implemented method comprising:
receiving, by one or more processors, data from one or more sources associated with a vehicle;
identifying, by the one or more processors, context information based upon, at least in part, the received data;
analyzing, by the one or more processors, audio data received in association with the vehicle based upon, at least in part, the context information; and
determining, by the one or more processors, modified context information based upon, at least in part, the received audio data and the context information.

2. The computer-implemented method of claim 1, wherein the one or more sources includes at least one of a navigation system, a calendar, a contact list, one or more Bluetooth devices associated with the vehicle, one or more vehicle sensors, one or more databases, an Internet connection, or one or more profiles associated with a person associated with the vehicle.

3. The computer-implemented method of claim 1, further comprising
receiving, by the one or more processors, input from one or more persons associated with the vehicle; and
processing, by the one or more processors, either the context information or the modified context information, based upon, at least in part, the received input.

4. The computer-implemented method of claim 1, further comprising
identifying, by the one or more processors, a keyword in the audio data received in association with the vehicle;
responsive to identifying the keyword, interacting, by the one or more processors, with one or more persons associated with the vehicle.

5. The computer-implemented method of claim 4, wherein interacting with the one or more persons in the vehicle further comprises:
presenting, by the one or more processors, a request for information from the one or more persons associated with the vehicle; and
receiving, by the one or more processors, input from the one or more persons associated with the vehicle.

6. A computer program product residing on a computer readable medium having a plurality of instructions stored thereon which, when executed by a processor, cause the processor to perform operations comprising:
identifying context information associated with at least one of a vehicle or one or more persons associated with the vehicle;
receiving data from one or more sources associated with the vehicle;
analyzing audio data associated with the vehicle, based upon, at least in part, the context information; and
determining modified context information based upon, at least in part, the analyzed audio data and the context information.

7. The computer program product of claim 6, further comprising
retrieving information based upon, at least in part, the modified context information; and
displaying at least one of the retrieved information or the modified context information.

8. The computer program product of claim 6, further comprising storing the modified context information.

9. The computer program product of claim 6, wherein the one or more sources includes at least one of a navigation system, a calendar, a contact list, one or more wireless devices in communication with the vehicle, one or more vehicle sensors, one or more databases, an Internet connection, or one or more histories associated with at least one person of the one or more persons associated with the vehicle.

10. The computer program product of claim 9, wherein the vehicle sensors include at least one of one or more exterior cameras of the vehicle, one or more dashboard cameras, one or more seat weight sensors, or one or more GPS devices.

11. The computer program product of claim 6, further comprising receiving the audio data associated with the vehicle from at least one of a microphone associated with the vehicle or a microphone of a wireless device associated with the vehicle.

12. The computer program product of claim 6, further comprising:
receiving, an indication from one or more persons associated with the vehicle for assistance; and
interacting with the one or more occupants of the vehicle wherein interacting with the on or more persons associated with the vehicle further comprises:
presenting a request for information from the one or more persons associated with the vehicle; and
receiving input from the one or more persons associated with the vehicle.

13. The computer program product of claim 12, wherein the indication from the one or more occupants of the vehicle comprises at least one of an input from the one or more persons associated with the vehicle or identifying a pre-defined keyword in the audio data associated with the vehicle.

14. A system comprising:
one or more computers comprising:
at least one processor; and
at least one memory storing computer-executable instructions, wherein the at least one processor is operable to access the least one memory and execute the computer-executable instructions to:
receive audio data in association with a vehicle;
analyze the received audio data;
generate context information based upon, at least in part, the analyzed audio data; and
determine modified context information based upon, at least in part, the context information and at least one of data received from one or more sources or the analyzed audio data.

15. The system of claim 14, wherein the at least one processor is further configured to execute the computer-executable instructions to:
retrieve information from one or more sources based upon, at least in part, the modified context information; and
display the retrieved information.

16. The system of claim 14, wherein the at least one processor is further configured to execute the computer-executable instructions to:
store the modified context information.

17. The system of claim 14, wherein the at least one processor is further configured to execute the computer-executable instructions to:
receive an indication for assistance; and
interact with one or more persons associated with the vehicle responsive to receiving the indication.

18. The system of claim 17, wherein the indication further comprises at least one of an input from the one or more persons associated with the vehicle or identifying a pre-determined keyword in the received audio data.

19. The system of claim 14, wherein the one or more sources includes at least one of a navigation system, a calendar, a contact list, one or more wireless devices in communication with the vehicle, one or more vehicle sensors, one or more databases, an Internet connection, or one or more histories associated with at least one of the one or more persons associated with the vehicle.

20. The system of claim 14, wherein the received audio data is received from one or more microphones of at least one of the vehicle or a wireless device associated with the vehicle.

21. The system of claim 14, wherein the at least one processor is further configured to execute the computer-executable instructions to:
receive an input from one or more persons associated with the vehicle; and
process either the context information or the modified context information based upon, at least in part, the received input.

22. A computer program product residing on a computer readable medium having a plurality of instructions stored thereon which, when executed by a processor, cause the processor to perform operations comprising:
receiving context information;
analyzing a first audio data set associated with a vehicle based upon the received context information;
modifying the context information based on the analyzing: and
transmitting the modified context information.

23. The computer program product of claim 22, further comprising:
receiving the modified context information, wherein the modified context information has been further modified based upon, at least in part, data received from one or more sources associated with the vehicle;
analyzing, a second audio data set associated with the vehicle based upon the modified context;
modifying the modified context information based upon the analyzing; and
transmitting the modified context information.

24. A system comprising:
one or more computers comprising:
at least one processor; and
at least one memory storing computer-executable instructions, wherein the at least one processor is operable to access the least one memory and execute the computer-executable instructions to:
receive context information;
analyze a first audio data set associated with a vehicle based upon the received context in formation;
modify the context information based on the analyzing; and
transmit the modified context information.

25. The system of claim 24, wherein the at least one processor is further configured to execute the computer-executable instructions to:
receive the modified context information, wherein the modified context information has been further modified based upon, at least in part, data received from one or more sources associated with the vehicle;
analyze a second audio data set associated with the vehicle based upon the modified context;
modify the modified context information based upon the analyzing; and
transmit the modified context information.
